(19) United States
(12) Patent Application Publication
(10) Pub. No.: US 2025/0233266 A1
(43) Pub. Date: Jul. 17, 2025

(54) BATTERY ASSEMBLY AND METHOD FOR FORMING BATTERY ASSEMBLY

(71) Applicant: GM Global Technology Operations LLC, Detroit, MI (US)

(72) Inventors: Raghavendra Saikrishna Keerthi Manda, Northville, MI (US); Subrahmanyam Goriparti, Troy, MI (US)

(21) Appl. No.: 18/413,385

(22) Filed: Jan. 16, 2024

(51) Int. Cl. H01M 50/46; H01M 50/466; H01M 50/54

(52) U.S. Cl. CPC H01M 50/46; H01M 50/466; H01M 50/54; H01M 2220/20

(57) ABSTRACT

A battery assembly defines a vertical axis and a longitudinal axis and includes a first electrode having a tab on a first end thereof in a first direction along the longitudinal axis, a second electrode in a stacked configuration with the first electrode along the vertical axis, and a separator that covers at least a second end of the first electrode in a second direction along the longitudinal axis.

### INTRODUCTION

The subject disclosure relates to vehicles, and in particular to a battery for vehicles.

Vehicle batteries undergo different conditions. A reliable battery able to withstand different conditions may be desirable.

### SUMMARY

In one exemplary embodiment, a battery assembly defines a vertical axis and a longitudinal axis and comprises a first electrode comprising a tab on a first end thereof in a first direction along the longitudinal axis, a second electrode in a stacked configuration with the first electrode along the vertical axis, and a separator that covers at least a second end of the first electrode in a second direction along the longitudinal axis.

In addition to one or more of the features described herein, the separator comprises a first portion positioned between the first electrode and the second electrode and a fold portion extending from the first portion that covers the second end of the first electrode.

In addition to one or more of the features described herein, the first portion of the separator covers an upper side of the first electrode along the vertical axis. The separator further comprises a second portion that extends from the fold portion and that covers a lower side of the first electrode along the vertical axis.

In addition to one or more of the features described herein, the battery assembly further defines a width axis. The separator covers both ends of the first electrode along the width axis.

In addition to one or more of the features described herein, the first end of the first electrode is not covered by the separator.

In addition to one or more of the features described herein, the second electrode comprises a tab at an end thereof in the second direction.

In addition to one or more of the features described herein, the first electrode is an anode and the second electrode is a cathode.

In another exemplary embodiment, a battery assembly defines a vertical axis and a longitudinal axis and comprises a plurality of first electrodes and a plurality of second electrodes that are alternatingly stacked along the vertical axis to form a stack, each of the first electrodes comprising a tab on a first end thereof in a first direction along the longitudinal axis, and a separator that covers at least a second end of each of the first electrodes in a second direction along the longitudinal axis.

In addition to one or more of the features described herein, the separator comprises a first portion positioned on an upper surface of each of the first electrodes and a fold portion extending from the first portion that covers the second end of each of the first electrodes.

In addition to one or more of the features described herein, the separator further comprises a second portion that extends from the fold portion and that covers a lower side of each of the first electrodes along the vertical axis.

In addition to one or more of the features described herein, the battery assembly further defines a width axis. The separator covers both ends of each of the first electrodes along the width axis.

In addition to one or more of the features described herein, the first end of each of the first electrodes is not covered by the separator.

In addition to one or more of the features described herein, each of the second electrodes comprises a tab at an end thereof in the second direction.

In addition to one or more of the features described herein, the battery assembly further defines a width axis. A wraparound portion of the separator is wrapped around both ends of the stack along the vertical axis and around both ends of the stack along the width axis.

In addition to one or more of the features described herein, tape is disposed on the wraparound portion to secure the battery assembly together.

In addition to one or more of the features described herein, a number of the first electrodes is one more than a number of the second electrodes.

In addition to one or more of the features described herein, the first electrode is an anode and the second electrode is a cathode.

In addition to one or more of the features described herein, the battery assembly further defines a width axis. A wraparound portion of the separator is wrapped around both ends of the stack along the vertical axis and around both ends of the stack along the width axis. The first portion, the second portion, and the fold portion of the separator covering each of the first electrodes and the wraparound portion of the separator are integrally formed of a single separator sheet.

In yet another exemplary embodiment, a vehicle comprises a rechargeable energy storage system comprising a battery assembly defining a vertical axis, a longitudinal axis, and a width axis. The battery assembly comprises a plurality of anodes and a plurality of cathodes that are alternatingly stacked along the vertical axis to form a stack, each of the anodes comprising an anode tab on a first end thereof in a first direction along the longitudinal axis, and each of the cathodes comprising a cathode tab at an end thereof in a second direction along the longitudinal axis, and a separator comprising a first portion positioned on an upper surface of each of the anodes along the vertical axis, a second portion positioned on a lower surface of each of the anodes along the vertical axis, and a fold portion extending from the first portion to the second portion that covers a second end of each of the anodes in the second direction along the longitudinal axis. The separator covers both ends of each of the anodes along the width axis. The first end of each of the anodes is not covered by the separator.

In addition to one or more of the features described herein, a wraparound portion of the separator is wrapped around both ends of the stack along the vertical axis and around both ends of the stack along the width axis.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is a is a left side view of a vehicle including a battery pack assembly having a battery according to one or more embodiments;

FIG. 2 is a top view of a battery assembly according to one or more embodiments;

FIG. 3 is a perspective view of a battery assembly according to one or more embodiments;

FIG. 4 is a schematic cross-sectional view of the battery assembly taken at 4-4 in FIG. 3;

FIG. 5 is a schematic cross-sectional view of the battery assembly taken at 5-5 in FIG. 3;

FIG. 6 is a flow chart showing a forming process of a battery assembly according to one or more embodiments;

FIG. 7A is a side view of step S1 in FIG. 6;

FIG. 7B is a top view of step S1 in FIG. 6;

FIG. 8A is a side view of step S2 in FIG. 6;

FIG. 8B is a top view of step S2 in FIG. 6;

FIG. 9 is a side view of step S3 in FIG. 6;

FIG. 10 is a side view of step S4 in FIG. 6;

FIG. 11 is a side view of step S5 in FIG. 6;

FIG. 12A is a side view of first and second steps of a forming process of a battery assembly according to one or more embodiments;

FIG. 12B is the first and second steps shown in FIG. 12A from an opposite side of FIG. 12A;

FIG. 12C is a schematic cross-sectional view taken at 12C-12C in FIG. 12B; and

FIG. 12D is a schematic cross-sectional view taken at 12D-12D in FIG. 12B.

### DETAILED DESCRIPTION

The following description is merely exemplary in nature and is not intended to limit the present disclosure, its application or uses. It should be understood that throughout the drawings, corresponding reference numerals indicate like or corresponding parts and features.

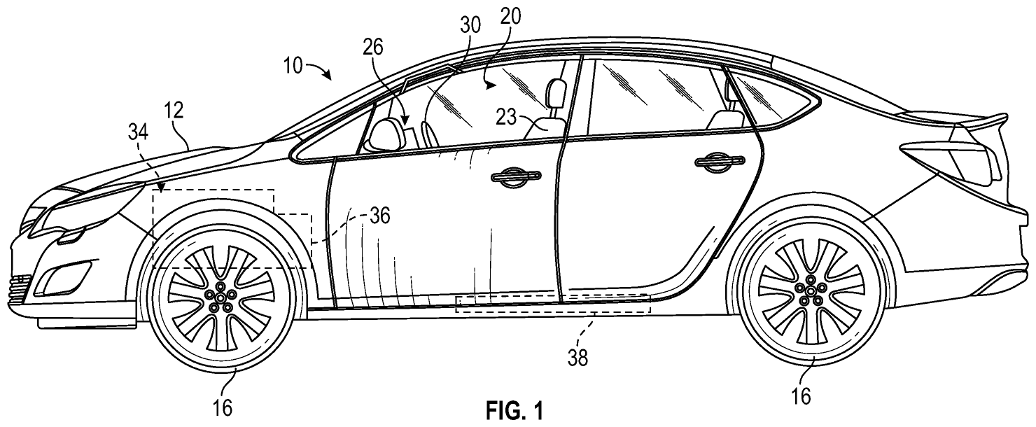

A vehicle 10 according to a non-limiting example is shown in FIG. 1. The vehicle 10 includes a body 12 supported on a plurality of wheels 16. One or more of the plurality of wheels 16 are steerable. The body 12 defines, in part, a passenger compartment 20 having seats 23 positioned behind a dashboard 26. A steering control 30 is arranged between seats 23 and a dashboard 26. The steering control 30 is operated to control orientation of the steerable wheel(s) 16.

The vehicle 10 includes an electric motor 34 connected to a transmission 36 that provides power to one or more of the plurality of wheels 16. A rechargeable energy storage system 38 is arranged in the body 12 and provides power to the electric motor 34. While specific locations are shown for the electric motor 34, the transmission 36, and the rechargeable energy storage system 38 in FIG. 1, these locations are merely exemplary and not limiting, and locations of these structures may vary.

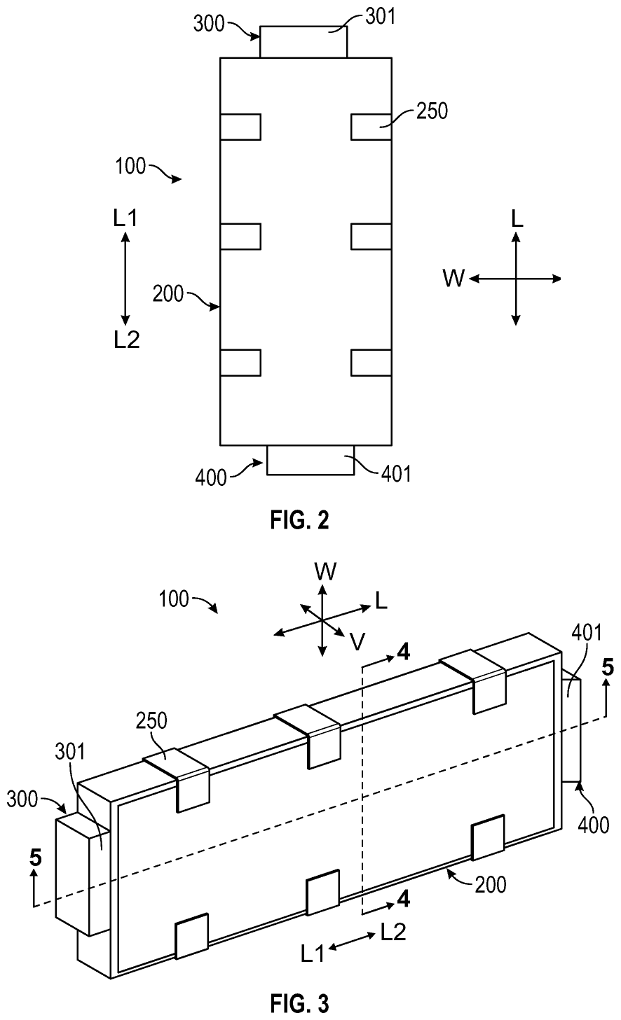

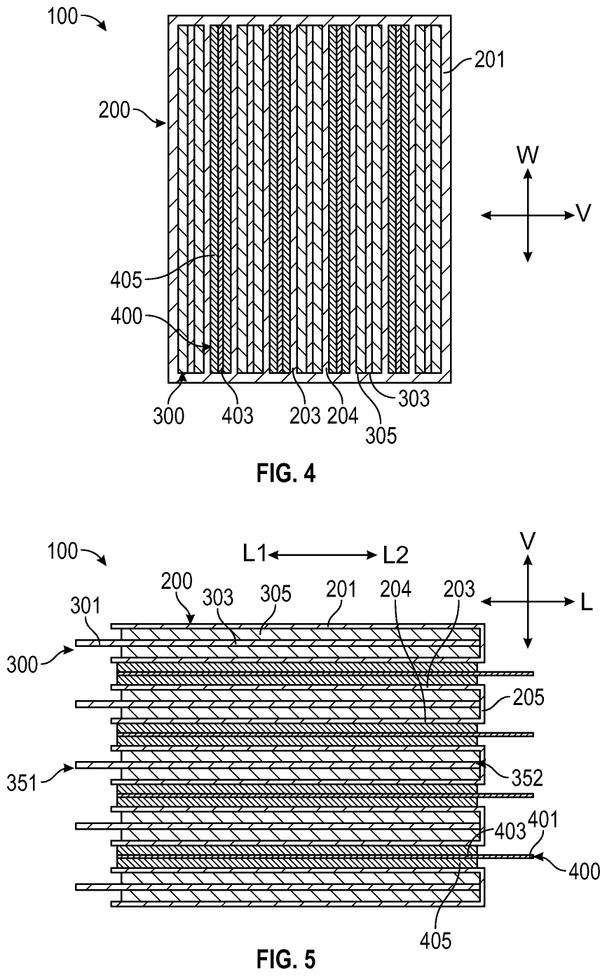

A battery assembly 100 according to one or more embodiments is shown in FIGS. 2 and 3. FIGS. 4 and 5 are schematic cross-sectional views of the battery assembly 100 taken at 4-4 and 5-5 in FIG. 3, respectively. According to one or more embodiments, the battery assembly 100 may be part of the rechargeable energy storage system 38 shown in FIG. 1.

The battery assembly 100 defines a vertical axis V, a longitudinal axis L, and a width axis W. According to a non-limiting example, the battery assembly 100 may have a length along the longitudinal axis L that is greater than a width along the width axis W, and the battery assembly 100 may have the width along the width axis W that is greater than a thickness along the vertical axis V. Alternatively, the width along the width axis W may be greater than or equal to the length along the longitudinal axis L. The battery assembly 100 includes a plurality of anodes 300 and a plurality of cathodes 400. The anodes 300 may be examples of first electrodes, and the cathodes 400 may be examples of second electrodes. While FIGS. 2-5 show five anodes 300 and four cathodes 400 for illustrative purposes, the present disclosure is not limited thereto, and the battery assembly 100 may include any number of the anodes 300 and the cathodes 400. The battery assembly 100 may include one more anode 300 than cathodes 400. That is, the battery assembly 100 may have n cathodes 400 and n+1 anodes 300, with n being a plural integer.

According to one or more embodiments, in the battery assembly 100, each of the anodes 300 includes an anode core 303 having an anode tab 301 at a first end 351 thereof in a first direction L1 along the longitudinal axis L, and anode outer layers 305 covering both sides of the anode core 303 with the anode tab 301 exposed. Each of the cathodes 400 includes a cathode core 403 having a cathode tab 401 at one end thereof in a second direction L2 along the longitudinal axis L, and cathode outer layers 405 covering both sides of the cathode core 403 with the cathode tab 401 exposed.

The battery assembly 100 further includes at least one separator 200. The anodes 300 and the cathodes 400 are in a stacked configuration, stacked alternatingly along the vertical axis V with the separator 200 therebetween. Specifically, as shown in FIGS. 4 and 5, each of the anodes 300 has a first portion 203 of the separator 200 positioned on an upper side along the vertical axis V, and a second portion 204 of the separator 200 on the lower side along the vertical axis V. The first portion 203 of the separator 200 may be positioned on an upper surface of the anode 300 and the second portion 204 of the separator 200 may be positioned on a lower surface of the anode 300. As the anodes 300 and the cathodes 400 are stacked alternatingly, the first portion 203 and the second portion 204 of the separator 200 separate the anodes 300 and the cathodes 400 along the vertical axis V. The separator 200 may be formed of an electrically insulating material.

Additionally, the separator 200 includes a fold portion 205 positioned on a second end 352 of each of the anodes 300 in the second direction L2 along the longitudinal axis L. The fold portion 205 may extend continuously between the first portion 203 and the second portion 204. The fold portion 205 may extend perpendicularly to the first portion 203 and the second portion 204. The fold portion 205 may be curved. When viewed along the width axis W, that is, within a plane including the vertical axis V and the longitudinal axis L, each of the anodes 300 may be covered by the separator 200 on three sides, with the first portion 203 covering the upper side of the anode 300 along the vertical axis V, the second portion 204 covering the lower side of the anode 300 along the vertical axis V, and the fold portion 205 covering the second end 352 in the second direction L2 along the longitudinal axis L.

The separator 200 may further include a wraparound portion 201 that wraps around a stack of the anodes 300 and the cathodes 400 along the vertical axis V and the width axis W. Thus, as shown in FIG. 4, when viewed along the length axis L, that is, in a plane that includes the vertical axis V and the width axis W, the wraparound portion 201 covers all four sides of the stack of the anodes 300 and the cathodes 400. The separator 200 including the first portion 203, the second portion 204, the fold portion 205, and the wraparound portion 201 may be integrally formed from a single separator sheet.

The separator 200 may cover both ends of each of the anodes 300 along the width axis W. That is, in the plane that includes the vertical axis V and the width axis W shown in FIG. 4, the separator 200 may cover all four sides of each of the anodes 300 along the vertical axis V and the width axis W. As the fold portion 205 covers the end of the anode 300 in the second direction L2 along the longitudinal axis L, each of the anodes 300 may have five sides covered by the separator 200, with an open end in the first direction L1 along the longitudinal axis L through which the anode tab 301 extends.

Tape 250 may be disposed on ends of the separator 200 along the width axis W to secure the battery assembly 100 together. While FIG. 3 shows the tape 250 on both sides of the separator 200 along the width axis W, the tape 250 may alternatively be disposed only on one side of the separator 200 along the width axis W.

As described above, the fold portion 205 of the separator 200 may cover the end of the anode 300 in the second direction L2, extending between the first portion 203 and the second portion 204 of the separator 200. Thus, even if the battery assembly 100 undergoes deformation, the cathode tab 401 is prevented from coming in contact with the anode 300 by the fold portion 205 of the separator 200.

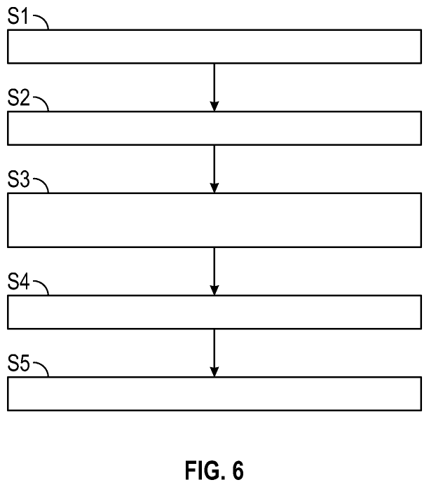

FIG. 6 is a flow chart showing a forming process of a battery assembly 100 according to one or more embodiments.

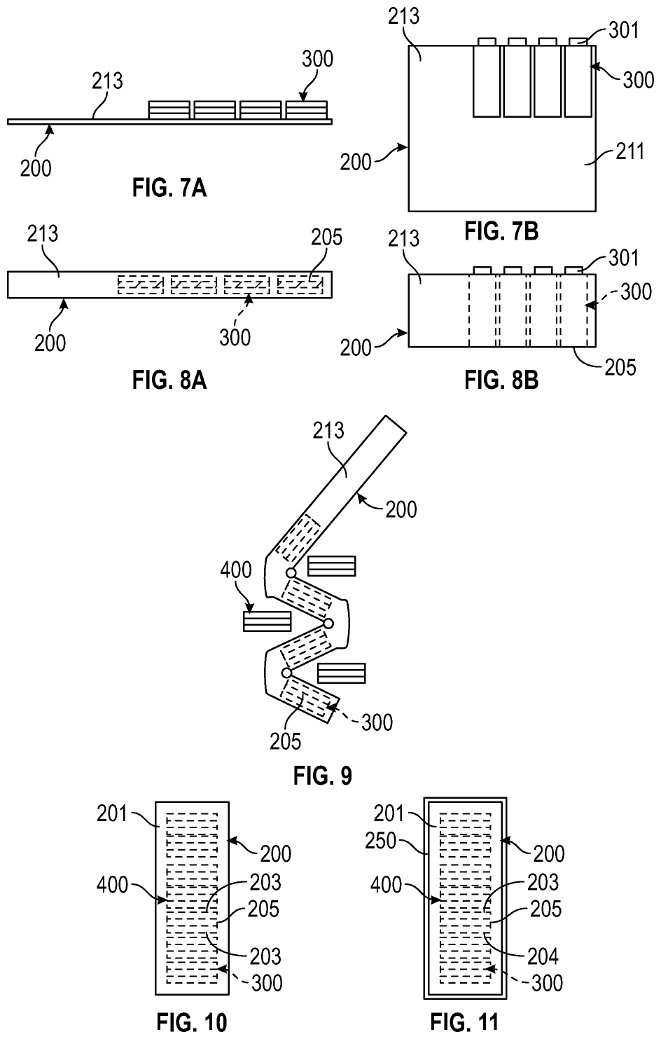

In step S1, which is shown in FIGS. 7A and 7B, the anodes 300 are positioned on a separator 200. For example, the separator 200 may be a separator sheet. While four anodes 300 are disposed on the separator 200 for illustrative purposes, this is not intended to be limiting, and any number of anodes 300 may be disposed on the separator 200. As shown in FIGS. 7A and 7B, the anodes 300 are placed side by side in a row on the separator 200, with the anode tabs 301 extending outwardly from the separator 200. The separator 200 is sized so as to have a first excess portion 211 not covered by the anodes 300 on one side of the row of the anodes 300, and a second excess portion 213 not covered by the anodes 300 on another side of the row of the anodes 300.

In step S2, which is shown in FIGS. 8A and 8B, the first excess portion 211 is folded over the row of anodes 300 such that each of the anodes 300 is covered on three sides, with the anode tabs 301 exposed from an uncovered side. As shown in FIG. 8A, by folding the first excess portion 211 over the row of anodes 300, the fold portion 205 of the separator 200 is formed covering the side of the anodes 300 opposite the anode tabs 301.

In step S3, which is shown in FIG. 9, the cathodes 400 are inserted between the anodes 300 in an alternating, zig-zag pattern, to form the stack of the anodes 300 and the cathodes 400 with separator 200 therebetween.

In step S4, which is shown in FIG. 10, the second excess portion 213 of the separator 200 is wrapped around the stack of the anodes 300 and the cathodes 400 to form the wraparound portion 201 of the separator 200. According to one or more embodiments, the second excess portion 213 of the separator 200 may be wrapped around an entirety of the stack of the anodes 300 and the cathodes 400 such that the wraparound portion 201 surrounds an entirety of the stack of the anodes 300 and the cathodes 400 along the vertical axis V and the width axis W. Alternatively, the second excess portion 213 of the separator 200 may be wrapped partially around the stack of the anodes 300 and the cathodes 400 such that the wraparound portion 201 surrounds only a part of the stack of the anodes 300 and the cathodes 400 along the vertical axis V and the width axis W.

In step S5, which is shown in FIG. 11, tape 250 is disposed around the separator 200 to secure the battery assembly 100 together. While FIG. 11 shows the tape 250 around an entirety of the separator 200 as a non-limiting example, several pieces of the tape 250 may be disposed on ends of the separator 200 along the width axis W to secure the battery assembly 100 together. Alternatively, the tape 250 may be disposed only on one side of the separator 200 along the width axis W.

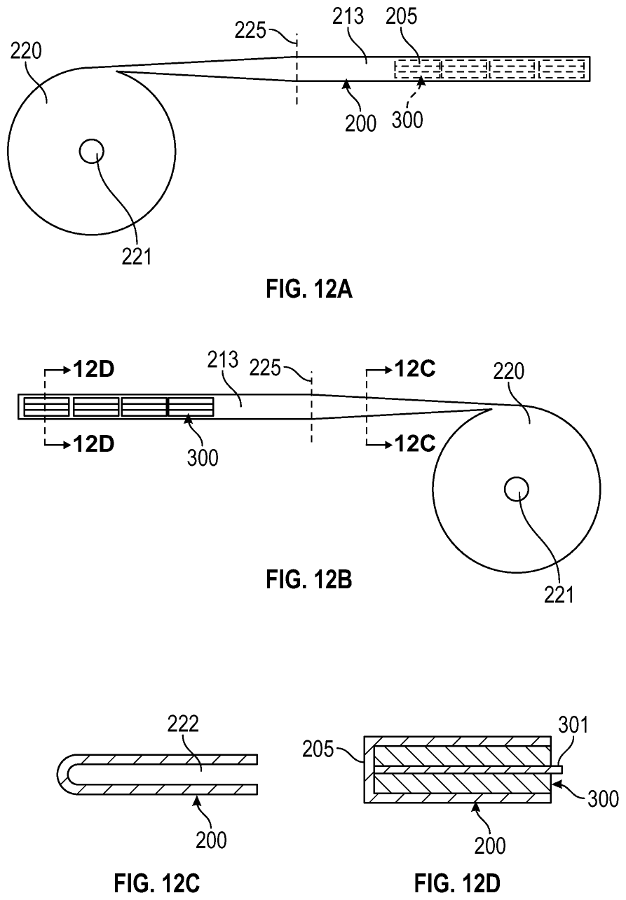

FIGS. 12A and 12B are views from opposite sides demonstrating first and second steps of a forming process of a battery assembly 100 according to one or more embodiments, and FIG. 12C and 12D are schematic cross-sectional views taken at 12C-12C and 12D-12D in FIG. 12B, respectively. This process includes separator 200 that is pre-folded and spooled around a rotatable core 221 to form a spool 220 of the separator 200. In the first step, the separator 200 is unspooled from the spool 220, and a plurality of the anodes 300 are inserted into a pocket 222 within the folded separator 200, with the anode tabs 301 of the anodes 300 facing away from the pocket 222. A portion of the separator 200 opposite the anode tab 301 forms the fold portion 205 of the separator 200. In a second step, the separator 200 is cut at cutting line 225. A portion of the separator 200 between the cutting line 225 and the anodes 300 forms the second excess portion 213. After the second step, the third, fourth, and fifth steps may correspond to the third step S3, the fourth step S4, and the fifth step S5 of FIG. 6 illustrated in FIGS. 9-11.

The above described processes may provide an efficient and effective method of forming the battery assembly 100 with the fold portion 205 of the separator 200 preventing contact between the anode 300 and the cathode tab 401, even if the battery assembly 100 undergoes deformation.

According to one or more embodiments, positions of the anodes 300 and the cathodes 400 may be swapped in the battery assembly 100 and process of forming the battery assembly 100 described above.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A battery assembly defining a vertical axis and a longitudinal axis, the battery assembly comprising:
a first electrode comprising a tab on a first end thereof in a first direction along the longitudinal axis;
a second electrode in a stacked configuration with the first electrode along the vertical axis; and
a separator that covers at least a second end of the first electrode in a second direction along the longitudinal axis.

2. The battery assembly of claim 1, wherein the separator comprises a first portion positioned between the first electrode and the second electrode and a fold portion extending from the first portion that covers the second end of the first electrode.

3. The battery assembly of claim 2,
wherein the first portion of the separator covers an upper side of the first electrode along the vertical axis, and
wherein the separator further comprises a second portion that extends from the fold portion and that covers a lower side of the first electrode along the vertical axis.

4. The battery assembly of claim 1,
wherein the battery assembly further defines a width axis, and
wherein the separator covers both ends of the first electrode along the width axis.

5. The battery assembly of claim 1, wherein the first end of the first electrode is not covered by the separator.

6. The battery assembly of claim 1, wherein the second electrode comprises a tab at an end thereof in the second direction.

7. The battery assembly of claim 1, wherein the first electrode is an anode and the second electrode is a cathode.

8. A battery assembly defining a vertical axis and a longitudinal axis, the battery assembly comprising:
a plurality of first electrodes and a plurality of second electrodes that are alternatingly stacked along the vertical axis to form a stack, each of the first electrodes comprising a tab on a first end thereof in a first direction along the longitudinal axis; and
a separator that covers at least a second end of each of the first electrodes in a second direction along the longitudinal axis.

9. The battery assembly of claim 8, wherein the separator comprises a first portion positioned on an upper surface of each of the first electrodes and a fold portion extending from the first portion that covers the second end of each of the first electrodes.

10. The battery assembly of claim 9, wherein the separator further comprises a second portion that extends from the fold portion and that covers a lower side of each of the first electrodes along the vertical axis.

11. The battery assembly of claim 8,
wherein the battery assembly further defines a width axis, and
wherein the separator covers both ends of each of the first electrodes along the width axis.

12. The battery assembly of claim 8, wherein the first end of each of the first electrodes is not covered by the separator.

13. The battery assembly of claim 8, wherein each of the second electrodes comprises a tab at an end thereof in the second direction.

14. The battery assembly of claim 9,
wherein the battery assembly further defines a width axis, and
wherein a wraparound portion of the separator is wrapped around both ends of the stack along the vertical axis and around both ends of the stack along the width axis.

15. The battery assembly of claim 14, wherein tape is disposed on the wraparound portion to secure the battery assembly together.

16. The battery assembly of claim 9, wherein a number of the first electrodes is one more than a number of the second electrodes.

17. The battery assembly of claim 9, wherein the first electrode is an anode and the second electrode is a cathode.

18. The battery assembly of claim 10,
wherein the battery assembly further defines a width axis,
wherein a wraparound portion of the separator is wrapped around both ends of the stack along the vertical axis and around both ends of the stack along the width axis, and
wherein the first portion, the second portion, and the fold portion of the separator covering each of the first electrodes and the wraparound portion of the separator are integrally formed of a single separator sheet.

19. A vehicle comprising:
a rechargeable energy storage system comprising a battery assembly defining a vertical axis, a longitudinal axis, and a width axis,
wherein the battery assembly comprises:
a plurality of anodes and a plurality of cathodes that are alternatingly stacked along the vertical axis to form a stack, each of the anodes comprising an anode tab on a first end thereof in a first direction along the longitudinal axis, and each of the cathodes comprising a cathode tab at an end thereof in a second direction along the longitudinal axis; and
a separator comprising a first portion positioned on an upper surface of each of the anodes along the vertical axis, a second portion positioned on a lower surface of each of the anodes along the vertical axis, and a fold portion extending from the first portion to the second portion that covers a second end of each of the anodes in the second direction along the longitudinal axis,
wherein the separator covers both ends of each of the anodes along the width axis, and
wherein the first end of each of the anodes is not covered by the separator.

20. The vehicle of claim 19, wherein a wraparound portion of the separator is wrapped around both ends of the stack along the vertical axis and around both ends of the stack along the width axis.
